(19) United States
(12) Patent Application Publication
(10) Pub. No.: US 2012/0056572 A1
(43) Pub. Date: Mar. 8, 2012

(54) APPARATUS AND METHODS FOR SYNCHRONIZED DISTRIBUTED CONTROLLERS

(75) Inventors: Robert A. Bigler, Cupertino, CA (US); Scott A. Morrill, Webster, NY (US); Carl R. Vogt, Rochester, NY (US); Keith R. Webster, Fairport, NY (US)

(73) Assignee: Animatics Corporation, Santa Clara, CA (US)

(21) Appl. No.: 13/042,247

(22) Filed: Mar. 7, 2011

Related U.S. Application Data
(60) Provisional application No. 61/311,489, filed on Mar. 8, 2010.

(51) Int. Cl. G05B 19/25; G05B 11/32

(52) U.S. Cl. 318/570; 318/625

(57) ABSTRACT

Intelligent servomotor controller, including integrated servomotor controller having motor with rotor in first housing; rotor position encoder producing measured position of rotor; microprocessor within second housing mating to first housing, electrically connected to rotor position encoder, serial communications port connecting to another integrated servomotor controller communicating desired rotor position command using serial digital data, microprocessor having software receiving desired position commands through communications port, computing error between desired position command and encoder-transmitted measured rotor reducing error signals to zero. Microprocessor is a position based servo system within second housing and rotor within first housing to desired position defined by communication with another integrated servo element. Microprocessor produces actuation signal to direct PID filter connected to microprocessor, PID filter providing drive amplifier servo control of supplying current to the motor. Cooperative communication facilitates synchronized action with integrated servo element. Embodiments also include method of operating IISMC group, including setting combined path target acceleration for IISMC; setting combined target velocity for IISMC; setting individual target position for IISMC; and initiating synchronized motion in the IISMC.

### CROSS-REFERENCE TO RELATED APPLICATIONS

This application is related to and claims the benefit of priority to U.S. Provisional Application No. 61/311,489; filed on Mar. 8, 2010, provided by the same inventors hereof and assigned to the same assignee hereof, and which Provisional Application is incorporated herein in its entirety.

### BACKGROUND OF THE INVENTION

1. Field of the Invention

The present embodiments are related generally to motor controllers, and more particularly to servo motor controllers.

2. Background Art

Machine design typically starts with a decision between centralized control and distributed control. Older servo controls representative of centralized control may include a central controller, individual amplifiers—one per axis of motion—mounted next to each other in a control cabinet, with individual motors equipped with respective encoders for positional feedback being distributed throughout the machine, where the shaft motion is required. An integrated servo controller can incorporate the controller and the amplifier into the motor/encoder unit itself. One or more sensors may be connected to the integrated servo controller's input/outports, leading to the motors being distributed out in the body of the machine.

Centralized control having one “master” in the system with every other component subservient to that master has the benefit of consolidating all programming and logic to one central point for easy support and debug. In centralized control, a “cable burden” may develop, taking all information and control signals back to a single control cabinet, or a task may be excessively burdensome, when the control tasks themselves prove too much for a single controller to handle. These challenges favor multiple, interoperating controllers, working together, in which distributed control and communications is at premium. Although multiple control or actuation nodes can be spread throughout the machine, optimally monitoring and controlling their portions of the overall process, one new challenge can arise in getting nodes to communicate with each other and to share salient information, and another challenge can come from coordinating the sequence timing of events across multiple “smart” nodes. While eliminating the cost of the centralized control is a great advantage, until recently the trade-off has been the burden of complicated communications between the integrated servo controllers.

### SUMMARY

The embodiments herein present apparatus and methods for an intelligent servomotor controller, including an integrated servo controller element having a motor having a rotor disposed within a first housing; a rotor position encoder associated with the rotor, the encoder producing an electrical signal indicating the measured position of the rotor; and a microprocessor mounted within a second housing, the second housing in mating relation to the first housing and electrically connected to the rotor position encoder, the second housing having a serial data communications port connectable to at least one other integrated servo element cooperatively communicating a desired rotor position command using serial digital data, the microprocessor having software which receives desired position commands through the communications port, repeatedly computes error signals between the desired position command and the measured position of the rotor as transmitted by the encoder, and reduces the error signals to zero. The microprocessor operates as a position based servo system within the second housing to bring the rotor within the first housing to a desired position defined by the cooperative communication with at least another integrated servo element. Also, the microprocessor produces an actuation signal to direct a proportional-integral-derivative (PID) filter connected to the microprocessor, the PID filter providing servo control of a drive amplifier supplying current to the motor. In addition, the cooperative communication facilitates synchronized action with the integrated servo element.

In some embodiments, the intelligent servomotor controller executes the synchronized action which includes the cooperative multi-axis coordinated action between or among at least two intelligent servomotor controllers effecting a controlled path velocity move. In other embodiments, the synchronized action further includes the cooperative multi-axis coordinated action between or among at least two intelligent servomotor controller effecting a controlled combined path velocity move. In still other embodiments, the cooperative multi-axis coordinated action between at least two integrated servo elements further includes a synchronized two-axis move cooperatively communicated from a first of the at least two integrated servo elements to a second of the at least two integrated servo elements. In yet other embodiments, the cooperative multi-axis coordinated action between at least two integrated servo elements further includes a synchronized three-axis move cooperatively communicated from a first of the at least two integrated servo elements to a second of the at least two integrated servo elements.

In yet other embodiments, the synchronized cooperative multi-axis coordinated action between at least two integrated servo elements further includes s a synchronized three-axis move cooperatively communicated between a first of the at least two integrated servo elements, a second of the at least two integrated servo elements and a third integrated servo element. Also, the cooperative multi-axis coordinated action between the first, the second, and the third integrated servo elements further comprises a three-axis controlled combined path velocity move. Moreover, the cooperative multi-axis coordinated action between the first, the second, and the third integrated servo elements further includes a command communicated to one of the first, the second, and the third integrated servomotor controller elements by a fourth intelligent integrated servomotor controller elements.

The embodiments also include method of operating an integrated servomotor controller (IMC) group, one method including setting a combined path target acceleration for the IMC group; setting a combined path target velocity for the IMC; setting an individual target position for selected ones of the IMC group; and initiating a synchronized motion in the IMC. The motion corresponds to at least one of the target acceleration, the target velocity or the target position, and the motion is representative of a synchronized motion. Furthermore, the IMC is an intelligent integrated servomotor controller. In another method embodiment, including after initiating, receiving information corresponding to a second synchronized motion; waiting for the synchronized motion to complete; and initiating the second synchronized motion. In an alternative method embodiment, after initiating, enqueuing information corresponding to a second synchronized motion; waiting for the synchronized motion to complete; and initiating the second synchronized motion. In some embodiments, the alternative method embodiment also may include executing an iterative programming element of programming material; and initiating a subsequent synchronized motion.

### BRIEF DESCRIPTION OF THE DRAWINGS

The figures herein provide illustrations of various features and embodiments in which:

FIG. 1 is a plan view of a combined motor body and controller of the present invention;

FIG. 2A is a side view of the motor body of FIG. 1;

FIG. 2B is a rear view of the motor body of FIG. 1;

FIG. 3 is a cross-sectional view of the motor body of FIGS. 2A and 2B;

FIG. 4A is a front view of the controller of FIG. 1 with a mounting flange attached at the rear end;

FIG. 4B is a rear view of the controller and flange of FIG. 4A;

FIG. 5 is a side view of the combined motor and controller of FIG. 1;

FIG. 6 is a plan view of a computer connected to a mounted motor and controller of FIG. 1;

FIG. 7 is an illustration of an intelligent integrated servomotor controller network, in accordance with the teachings of the present invention; and

FIG. 8 is an example flow diagram of an example process in accordance with the teachings of the present invention.

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated.

### DETAILED DESCRIPTION OF THE EMBODIMENTS

The present embodiments pertain to one or more integrated servomotor controllers cooperatively executing programming material by which synchronized motion can be obtained. An intelligent integrated servomotor controller element is a constituent of an intelligent integrated servomotor network, in which elements may function autonomously, or be facilitated by cooperative communication with one or more other intelligent servomotor controller elements. An integrated servomotor controller element can be a controller that is mated to a DC motor with a set of rigid, electrically conductive pins protruding from a back end of the motor. Both the motor and the controller are modular, providing for ease of interchange or replacement of either the motor or controller. The pins provide mechanical as well as electrical connection between the motor and controller. Electrical connection of the pins to the controller allows communication of power and control signals for the motor from the controller, and communication of data regarding measured positions of the motor for the controller. The motor may employ brushes, although typically it is brush less, as a brushless motor provides improved heat dissipation from the coils of a stationary, exterior housing rather than the coils of a rotating armature found with brushes. A rotor protrudes from a front end of the motor, while mounted on a back end of the motor is an optical encoder for measuring incremental positioning of a rotor relative to the motor housing. The encoder has leads which, like the pins, extend from the back end of the motor to fit into matching connections in the controller. The motor includes Hall sensors for determining local magnetic fields within the motor for absolute position measurement of the rotor. Unlike typical servo motors, the integrated servomotor controller element can remain connected with an application while the controller is removed for adjustment or replacement. Aside from the pins, the motor and controller are held together with three screws which can be easily removed. The controller is of the same diameter as the motor, and may extend about as far as a traditional encoder, allowing use in tight spots that are common in modern motion control applications.

The integrated servomotor controller element includes a microprocessor with a servo amplifier for driving the motor and a proportional integral derivative (PID) filter for controlling the motor based upon feedback from the motor. The controller has a communications port that may be accessed by an RS-232 plug, for example, from a personal computer, or from other coupled integrated servomotor controller elements. Two or more integrated servomotor controller elements can be linked together via their communication ports to provide multi-axis motion with the controllers and their connected motors synchronized. A peripheral element port located adjacent to the communications port on a back end of the controller affords connections for elements such as a flat panel display, which may be mounted on the controller and display information regarding the motor or controller, or joystick for controlling the motor. The modular, mated combination of motor and controller reduces wiring and electronic connections, offering space savings and improved reliability. The reduction in wiring benefits the accuracy of motor control by reducing signal interference in critical drive and servo control functions. Space savings and convenience also result from the compact structure and lack of electronic components that require mounting and interconnection. An example of such a integrated servomotor controller, an 12NC device, may be found in U.S. Pat. No. 5,912,541 (BIGLER, et al.), “INTEGRATED DC SERVO MOTOR AND CONTROLLER,” issued Jun. 15, 1999, which patent hereby is incorporated by reference in its entirety.

An I2NC device can be an entire servo system built within a servo motor, including an including a controller, an amplifier, and an encoder, with a microprocessor providing servo functions and proportional integral derivative filtering. When powered, an I2NC device may respond to an internal program, to external serial commands or to both. An example of an I2NC device may be a Class 5 SmartMotor™ integrated motor, produced by Animatics Corporation, Santa Clara, Calif. USA. Similarly, an example of a document describing the programmability, networking, I/O functionality, and servo performance as examples of expressions of methods, techniques and functions herein may be found in the SmartMotor™ User's Guide: Class 5 Smart Motor™ Technology with Combitronics™ also from Animatics Corp (together, the Integrated Motor Protocol—IMP). The SmartMotor™ User's Guide is incorporated by reference herein in its entirety. I2NC devices, when interconnected to form a network, can communicate using multiple protocols. For example, an I2NC device can receive and respond to command or data delivered to it over a serial bus using a Controller Area Network (CAN) Standard protocol, a CANopen protocol, a DeviceNet protocol, a serial RS-232 based protocol or a serial RS-485 protocol. An I2NC device can be configured to move when the device receives a command stating a target position, a maximum velocity, or a maximum acceleration.

An intelligent integrated servomotor controller element (IISMC) can be an integrated servomotor controller element, which can be addressable and be programmed to operate autonomously. However, IISMC can be an integral element in an intelligent integrated servomotor controller network in which constituent elements can cooperatively communicate (receive, send, and forward) commands for execution, parameters, variable, encoder values, status values and settings, to other IISMC, in a peer-to-peer-type of communication, which may be multidirectional. Moreover, similar to an IISMC, an intelligent integrated servomotor controller element (IIMC) can be an integrated motor controller element, which can be addressable and be programmed to operate autonomously. An IIMC can control motors, in general, including, without limitation, an AC motor, a DC motor, or a stepper motor, in general, without the need for an explicit “servo” element. The addressability of each IISMC, or an IIMC, allows information to be cooperatively communicated, for example, by appending the target address to the information intended for the target IISMC. An IISMC network, like an IIMC network, is capable of performing synchronized movements, fluidly and precisely, using adaptive cooperative communications between or among coupled IISMC network elements. Further discussion about the overall function of an IISMC element or network, will draw explicit parallels with an IIMC element or network, again, mutatis mutandi.

In addition to communicating with other IISMC elements, for example using a CAN-like 29-bit identifier, an IISMC element can be coupled to a servo controller in a CAN network and can communicate therewith using CAN frames over a serial communication link. Using this communication technique, IISMC networks can be able to communicate with each other over a CAN-type network without interfering with CAN network communications or operations. At the same time, the connected IISMC elements can be “unseen” by the CAN-type network elements. An IISMC network can be adapted to co-exist with network types other than a CAN-type network by virtue of shared serial communication links used by the IISMC network or the other network.

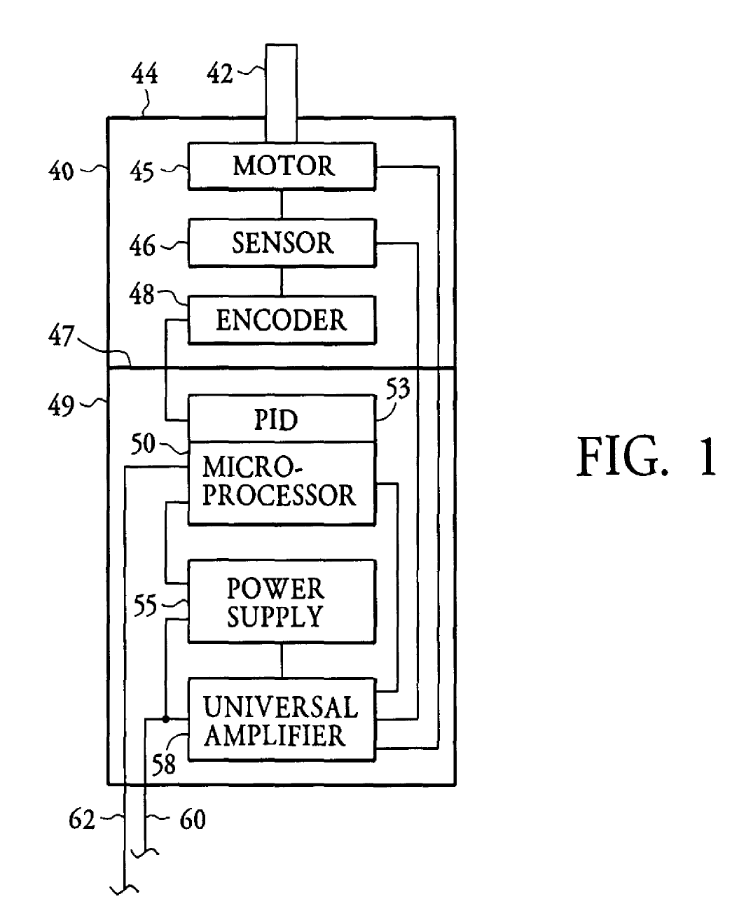

Referring now to FIG. 1, an intelligent integrated servomotor controller element (IISMC) can include an integrated servomotor controller executing cooperative, adaptive programming material, which may actualize, among other goals, synchronized multiple axis motion. It must be understood that the motor 45 can be an AC motor, a DC motor, or a stepper motor, mutatis mutandi, and the invention is not constrained by other motor types. A motor of an IISMC or an IIMC can be configured to be uniquely addressed. An IISMC motor or IIM motor can be addressed, and information sent or received, simply by appending the motor address to the intended information. An example motor hereby is illustrated. A motor body 40 is shown with a rotor 42 protruding from a front end 44 of the body 40. Within the body 40 is a motor 45 and a Hall sensor 56. At a back end 47 of the motor body 40 is an encoder 48. A controller 59 adjoins the back end 47 of the body 40. The controller 49 houses a microprocessor 50 including an feedback control loop 53. Loop 53 may reduce errors signal to substantially zero and, in this context, loop 53 can be an adaptive loop. Loop 53 and motor 45 element of an adaptive network of integrated motor controllers. Although a proportional-integral-derivative (PID) also may be used, it is not a requirement. Controller 49 also contains a power supply 55 and a universal amplifier 58. Direct current (DC) power of between about 18 to about 48 volts can be provided to the controller 49 through a power input 60, and formatted signals using the well-known RS-232 protocol, or other formatted signals may be provided to the controller 49, via a communications port 62.

The power input 60 can be connected to the power supply 55 and the amplifier 58. The power supply 55 stores power and provides requisite levels of DC power to different elements of the controller 49, including the microprocessor 50 and the amplifier 58. Signals input to the microprocessor 50 via the communications port 62 are used to run the motor 45 by controlling the current supplied to the motor from the amplifier 58. A position of the motor 45 is measured by the sensor 46 and encoder 48 and information regarding this position is sent to microprocessor 50 for servo control of the motor 45.

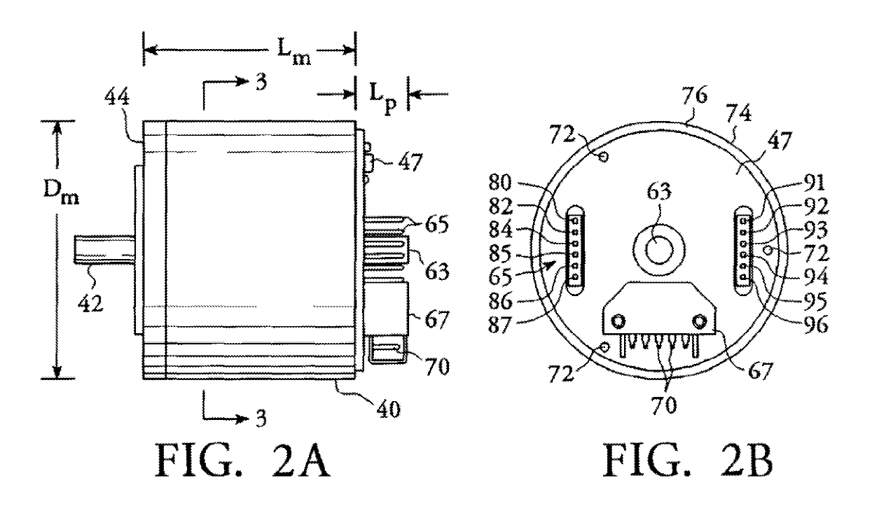

FIGS. 2A and 2B show some elements of the motor body 40 that connect with the controller 49. The body 40 is protruding from the front end 44 and a rotor tail 63 extending from the back end 47. In an embodiment of integrated servomotor controller 49, the motor body 40 has a length Lm that lies within a range of between 1 inch and several inches, optimally about 2 inches, and a similar outside diameter Dm, optimally about 2.25 inches. A set of electrically conductive pins 65 protrude from the back end 47 adjacent to the rotor tail 63. The pins 65 are grouped in a parallel pair of rows that are vertically oriented and centered horizontally beside the rotor tail 63. An encoder 67 is disposed adjacently below the rotor tail 63, and has a series of electrical leads 70 that extend away from the back end 47 in a direction substantially parallel to the rotor tail 63 and the pins 65. The encoder 67 directs light at the rotor tail 63, which is marked to reflect light from certain spots and not from others, and the encoder 67 detects reflected light from the tail 63 in order to determine an incremental position of the rotor 42. Data regarding this position is sent to the controller 49, shown in FIG. 1, via the leads 70. Three tapped screw holes 72 are located near a perimeter 74 of the back end 47 for affixing the controller 49 to the motor body 40. An annular recess 76 is disposed at the perimeter 74 for axial alignment of the controller 49.

In an embodiment, a motor body 40 size is designed to accommodate standard NEMA23 frame dimensions and tolerances, allowing retrofit of existing 23 size stepper motors. However, other sizes may be accommodated. For this size, the pins 65 have a length LP of approximately 0.5 in., and a cross-sectional area of 0.025 square inches. The rows of pins 65 are spaced about 1.5 inch from each other on opposite sides of the rotor tail 63, each row having 6 pins with centers spaced apart by about 0.1 inch. A first pin 80 provides 5 volts DC power to the motor 45 return path for that power. A third pin 84 offers a ground connection for the body 40. Alternatively, alternating current (AC) may be used by an AC motor. The other three pins 85, 86, and 7 in that row are connections for three Hall sensors, not shown, that provide signals to the controller 49 regarding the magnetic field within the motor 45, measured by transverse electrical current, thereby measuring a general position of the rotor 42. The six pins 65 in the opposite row, labeled 91, 92, 93, 94, 95 and 96 provide power to a set of six windings, which encircle the rotor 42 within the motor 45, providing changing magnetic fields to power the rotor 42.

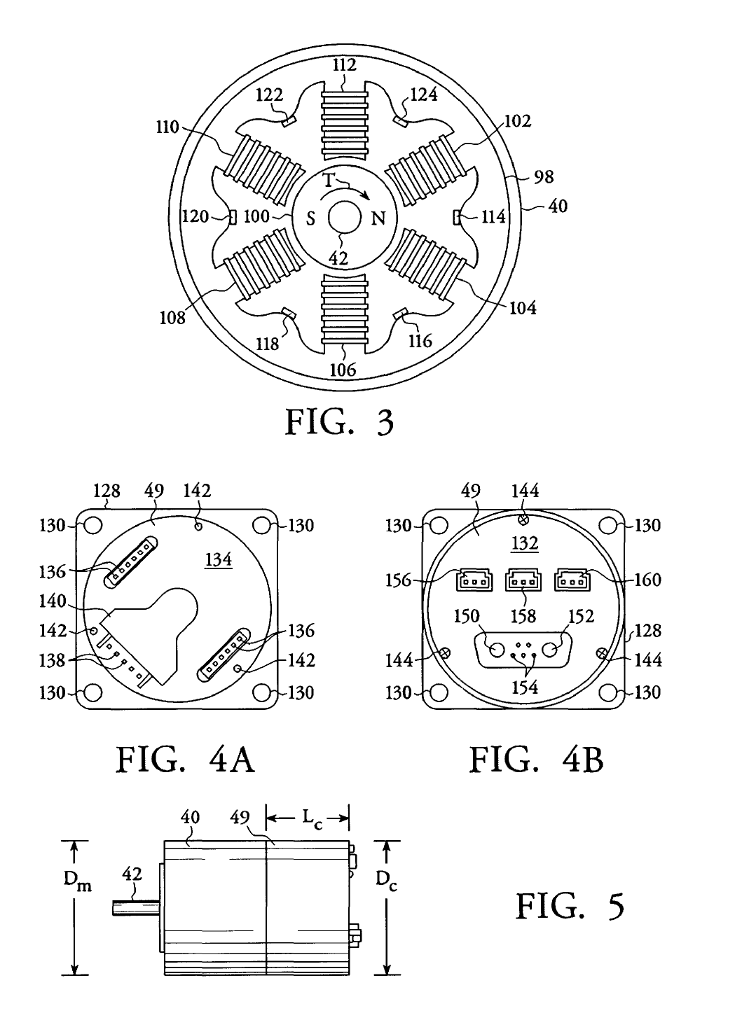

FIG. 3 shows a simplified axial view of a portion of the motor body 40 containing the motor 45 with a stator 98 outside and the rotor 42 at the center. The rotor 42 is electrically insulated from the stator 98 contained in the motor body 40. The rotor 42 is attached to a cylindrical permanent magnet 100 having a diameter larger than that of the rotor 42 and opposed north (N) and south (S) poles. Six windings, labeled 102, 104, 106, 108, 110, and 122 surround the permanent magnet 100, with adjacent windings being oppositely wound and thus producing oppositely directed magnetic fields when supplied with electrical current. The windings are connected as pairs so that current flows through a pair of adjacent windings simultaneously to provide a torque to the magnet 100 and thereby turn the rotor 42. For example, pins 91 and 92 (FIG. 2B) provide and drain current from windings 102 and 104, respectively. Winding 102 is oriented so that current provided by from pin 91 creates a magnetic field having a north pole directed toward the rotor 42 and a south pole directed away from the rotor 42. Current from winding 102 flows to winding 104 by a wire, not shown, and drains from winding 104 through pin 92. Winding 104 is oriented so that this current creates a magnetic field with a south pole directed toward the rotor 42. With the north pole (N) of the magnet 100 oriented as shown in FIG. 3, the just described current in windings 102 and 104 produces a torque T that tends to cause magnet 100 and rotor 42 to rotate in a clockwise direction.

Referring now to FIGS. 4A and 4B, front and rear views of the controller 49 show a square flange 128 which is attached to a rear end 132 of the controller 49, the flange 128 having bolt holes 130 near its corners to allow mounting of the controller 49 to a work surface, not shown. A front end 134 of the controller 49 has 12 pin holes 136 configured in a parallel pair of rows, the pin holes 136 mating with the pins 65 of the motor body 40. Another row of sockets 138 mates with the pins 70 from the encoder 67. The front end 134 has a recess 140 to allow for the extension of the rotor tail 63 and the encoder 67 from the back end of the motor body 40. A triad of apertures 142 allows passage of screws 144 from the rear end 132 to the screw holes 72, for attachment of the controller 49 to the motor body 40. The controller 49 can be removed from the motor body 40 by simply unscrewing these screws 144 and pulling the pins 65 and 70 free, allowing the motor body 40 to remain attached to an application while the controller is removed for repair or replacement.

The rear end 132 of the controller 49 contains a number of electrical ports providing power and communication to the controller 49. DC power of from 5 to 18 volts is provided to power socket 150 and drained from power socket 152. A set of sockets 154 compatible with RS-232 or other computer communication cabling provides capability to program or change settings of the controller 49 via a personal computer or other compatible element. These sockets 154 also allow interconnection between a plurality of controllers 49 and attached motor bodies 40 to perform coordinated tasks. A synchronization pin located within each controller 49, not shown, allows a plurality of controllers 49 and their associated motors 45 to be perfectly synchronized despite the small delays inherent in RS-232. Interconnected motor bodies 49 can be held by their associated controllers 49 by mounting on a work piece, not shown, so that their rotors 42 are oriented in different directions or along different axes to provide precisely controlled quantities of motion in any direction. A left limit port 156 provides control of motion of the rotor in a clockwise direction while a right limit port 158 sets a limit on motion in a counterclockwise direction. A peripheral port 160 provides the opportunity to link peripheral elements such as joysticks, mice, displays or push-wheel inputs.

FIG. 5 displays the controller 49 attached to the motor body 40, demonstrating that the controller 49 adds little to the length of the motor body beyond that typically assumed by an encoder of the prior art. The controller 49 has a length Lc that may range from about 1 inch to several inches, depending primarily upon the number of circuit boards stacked within the controller 49. The diameter of the controller Dc can be seen to match the diameter, Dm of the motor body 40, allowing the mated body 40 and controller 49 to fit in a similar lateral space as the motor body 40 would fit in alone. Alternatively, a housing for controller 49 and motor body 40 can be a single unit or plural units to secure the controller therewithin.

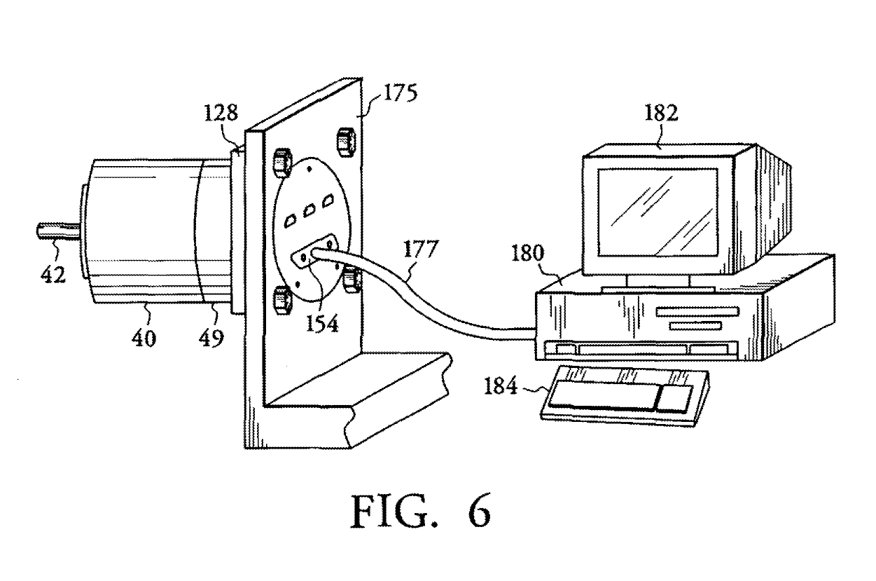

FIG. 6 shows the motor body 40 and controller 49 attached by the flange 128 to a support 175. An RS-232 cable 177 is connected through a hole in the support, to the RS-232 port 154 of the controller, and also connected to a personal computer 180. Information regarding parameters of the motion of the rotor 42 can be displayed on a terminal 182 connected to the computer 180. A keyboard 184 is used to input desired motion parameters into the computer 180 which inputs data into the controller 49 to precisely control the rotor 42. There is a large amount of information that a controller 49 can volunteer to a host computer 180, a peer controller 49, or a peripheral display, not shown. This information includes an actual position, velocity, encoder error or motor status, which is sent over the cable 177 as a byte of information.

The position, velocity or acceleration of the rotor 42 can be programmed into the controller 49 with up to 32 bits of precision in any of those parameters, yielding extremely fine resolution. Numeric resolution doubles with each additional bit. Thus a 32 bit quantity does not have twice the resolution of a 16 bit quantity, but instead has 65,536 times that resolution. As an example, when photographing a distant star by opening a shutter of a telescope camera that is set to rotate as the earth rotates, resolution becomes very important. If an astronomer calculates that a rotation of 0.00294785 rpm is needed for this purpose and a 16 bit resolution control system chops off the last 3 digits, the picture that results will be a dash, not a dot. With a 32 bit system, in between each velocity at which a 16 bit system could track are 65,536 more velocities from which to choose—a total of over 4 billion positions.

This extreme resolution allows for very accurate linear interpolation of many cascaded integrated motors 45 and controllers 49. It is essential in this case to assure that all the rotors 42 start at the same time. Millisecond delays of RS-232 can degrade synchronization, and can be averted by first inputting commands for the chain of motors 45 into the microprocessors 49 and then using internal timers of the microprocessors 49 and synchronization pins to initiate motion of each of the rotors 42 simultaneously.

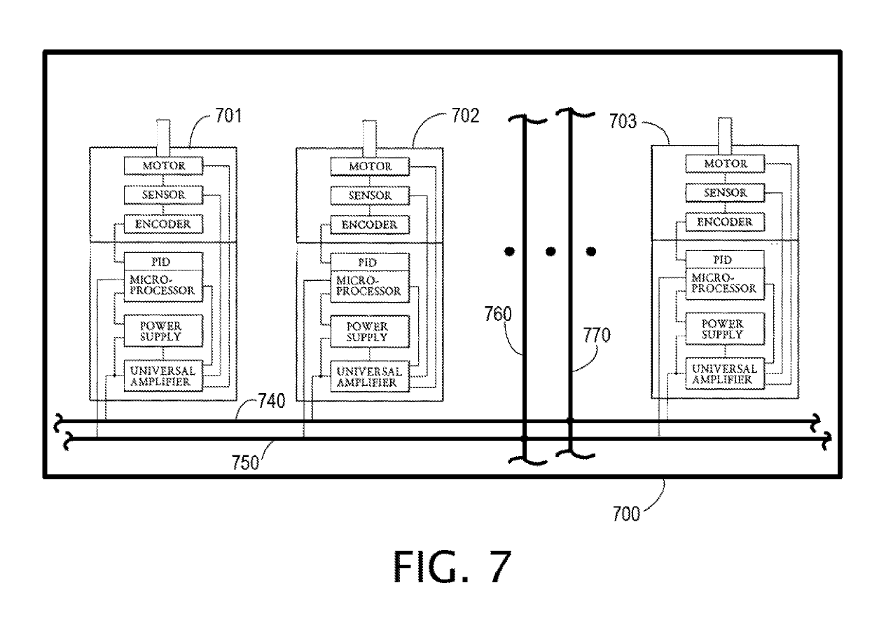

Referring now to FIG. 7, an IISMC network 700 can include a series of connected intelligent integrated servomotor controllers 701-703 in one potential controlled motion network 700 configuration, although others are possible. Alternatively, network 700 may be an IIMC network, although network 700 will be described with respect to an IISMC network 700. Typically, each IISMC 701-703 can be coupled with another IISMC 701-703 using a serial communications link 750 by which cooperative communication may be performed. IISMC 701-703 also can be coupled to a power link 740, by which to apply power to the respective intelligent servomotor controller 701-703. Each IISMC can be identified on a network by an address, and the address of the IISMC can be used to identify a controller location to receive or report information. The address can simply be appended to IISMC commands following a delimiter.

As noted previously, IISMC 701 can be an integral element in an interconnected, adaptive CAN-type network that can cooperatively communicate information. Information can be, without limitation, commands for execution, parameters, variable, encoder values, status values and settings, to other IISMC, in a peer-to-peer-type of communication. An IISMC element may receive, send, or forward information over the intelligent network to other IISMC element coupled to the communication link. An IISMC network is capable of using adaptive cooperative communications between or among coupled IISMC network elements for performing synchronized movements in response to adaptively cooperatively communicated information prior to, or during, a period of motion.

In FIG. 7, a network 700 in the form of a serial chain of interconnected intelligent integrated servomotor controllers is illustrated, although this is not the only manner by which IISMC elements in a network may be interconnected, for example, without limitation, in a mesh, or a star, or a pseudorandom distribution, of controllers, as indicated by busses 760, 770. Indeed, in prior servo motor system arrangements the various use of centralized master, or even distributed master may have made for complex intercommunication architectures and protocols, with a limited number of architectures and communicating protocols being thought suitable, if marginally so, for a given application. Embodiments of the current apparatus and methods, can allow for cooperative intercommunication between or among IISMC embodiments, thereby simplifying links and permitting networked IISMC to cooperatively intercommunicate in order to carry out motion fitting a predetermined motion profile. It must be understood that intelligent servomotor controller embodiments herein are not exclusively configured for use with each other, but also may be used, individually, or on a subnet, with other servomotor systems.

One of the IISMC, e.g., controller 701, can receive an cooperative information such as operational program or preselected commands, from another IISMC, such as controllers 702 or 703, which can transmit to receiving element IISMC 701 via communication link 750. For example, IISMC 703 can cooperatively forward information to IISMC 701 via IISMC 702. In addition, IISMC 701, 702, or 703 can operate autonomously when programmed, can execute programming material before or during operation, or transmit or receive information, cooperatively, during operation. One of the IISMC, e.g., controller 701, can cooperatively receive information such as operational program or preselected commands, from a remote computer. Controller 701 then can disseminate all or a portion of the operational program, the preselected commands or second preselected commands to one or more of controllers 702-703. Indeed “leapfrog” programming may be effected, where the respective programming material is moved from a first, then a second, and then a third controller and so on, in series, in parallel, or in a combination of series and parallel until the desired programming material is received by the respective target IISMC 701-703.

Information communication can be multidirectional, for example, where a receiver of programming material becomes a sender of programming material to a prior recipient. Information also may be forwarded through at least one intermediate from sender IISMC element to recipient IISMC recipient. Such multidirectional cooperative communication also permits variable, index, encoder data, communication rate, and physical limit, positional, or movement (acceleration or velocity) information to be cooperatively communicated between or among coupled controllers, thus permitting an entire palette of synchronized motions among intelligent servomotor controllers, and other servo controllers cooperatively coupled thereto.

APPENDIX A represents examples of BASIC-like commands and meanings which may be used to create fluid synchronized motion among present embodiments of cooperative IISMC elements. In general, when a description of a command states that the command is an assigned value, this means that a command such as VA typically could be used be used in the form of VA=2*a. Also, when a meaning states that a value is ‘reported,’ then that command typically stands alone on a line, and prints results to an active serial interface, in the example form of RVA (report VA). Moreover, when a description of a command states that a command ‘Sets’ a value, then that command typically is located on the right-hand side of an equals sign, such as b=ADT, meaning “Set variable b to the current value of acceleration and deceleration.” In addition, command meanings that do not specify one of these conditions are simply commands that complete an action and stand alone on a line. Furthermore, an IISMC command, variable, or constant (i.e., information) can be directed to a respective IISMC by virtue of simply appending the IISMC address to the information. For example, the simple syntax command:address may be used to remotely execute a command on a motor having an identified address. Although some of the commands of APPENDIX A may not be used by an IISMC, instead being directed to other functional elements, the compilation is an example of the flexible addressability provided by present embodiments of IISMC. APPENDIX A is hereby explicitly incorporated herein, in its entirety.

IISMC, or IIMC, are devices, which can be located by reference. That is, an IISMC can be assigned an address, which may be unique, and then be contacted by a simple reference to that address. For example, the IISMC address may be appended (or prepended) to a motor command. An IISMC can be contacted by appending an address corresponding to the IISMC. A simple delimiter, such as a colon (:) may be used to denote that the value following the colon is an address of an IISMC, although other techniques are possible. Such explicit addressability provides a programmer with a great amount of flexibility and certainty when preparing code to embed in an IISMC or to direct a remote IISMC during operations, relative to present day controller communication. When IISMC communicate, information may be sent to the IISMC at the respective IISMC address, greatly reducing the explicit need for two-way print for each peer-to-peer communication, increasing the network available bandwidth. Similarly, this addressability allows one IISMC to report or request information from another IISMC on-the-fly, also by appending a command with a known address. Similar functionality is provided to an IIMC element.

Examples of the simplicity, and power, of IISMC (or IIMC) addressability embodiments include:

| | |
|---|---|
| OUT(3) = IN(2) | ‘Output #3 equal to input #2 |
| OUT(3) = IN(2):5 | ‘Output #3 equal to input #2, motor #5 |
| OUT(3):7 = IN(2):5 | ‘Output #3, motor #7 equal to input #2, motor #5 |
| GOSUB(500):9 | ‘Motor #9 directed to execute subroutine 500 |

Addressability provides rapid identification of and communication with a target IISMC or an IIMC. It also allows commands to be sent to selected addressable IISMCs in a network, in advance of execution by the target IISMCs. Commands and other information also can be transmitted to, and received by, a target address while the IISMC is performing an operation. This permits IIMSC to report information to or receive information from, other controllers over time, giving sustained synchronization. Moreover, in effect, by reference addressability of a network of adaptive systems suggests a high performance adaptive network of IISMC.

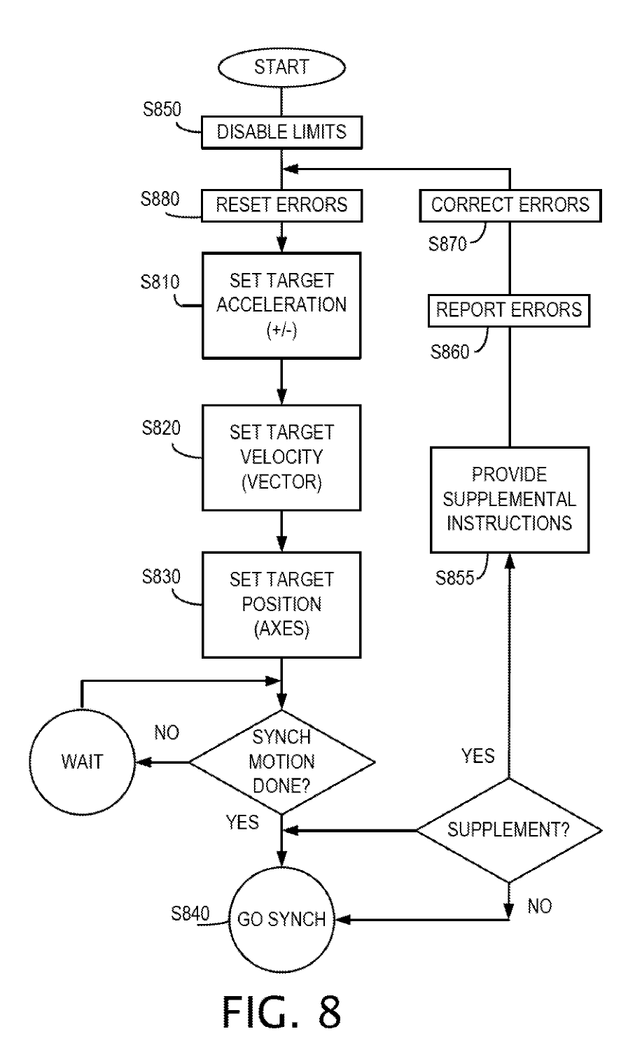

FIG. 8 illustrates an example of a flow diagram depicting a basic synchronized motion trajectory method (S800) in accordance with the present invention. The method with an IISMC group can proceed by setting a combined path target acceleration for the IISMC group (S810), setting a combined path target velocity for the IISMC group (S820), setting an individual target position for the IISMC group or selected ones of the IISMC group (S830), and issuing a “GO” command (S840), which may be a GO SYNCHRONIZED (GS) command. Also, the method may include disabling limits (S850) for the IISMC group or selected ones, reporting errors (S860), or resetting errors (S880) before continuing with other programming elements. Providing supplemental information (S855) may be desired during operation, as well, to achieve a preselected target position in a two-axis plane or a three-axis space. Using APPENDIX A as an example source of commands, the following code vignette may be used:

| | |
|---|---|
| EIGN(2) | ‘Disable Left Limit |
| EIGN(3) | ‘Disable Right Limit |
| ZS | ‘Reset Errors |
| ADTS = 100 | ‘Set Target Acceleration |
| VTS = 100000 | ‘Set Target Velocity |
| PTS = (30000:1, 40000:2) | ‘Set Target Position for Axes 1, 2 |
| GS | ‘Go, Start the Move |
| TSWAIT | ‘Wait - Complete Current Motion |
| PTS = (40000:1, 30000:2) | ‘Set New Target Pos'n, Axes 1, 2 |
| GS | ‘Go, New Target Position SYNCH |

TSWAIT can be equivalent to a WHILE . . . LOOP command (see APPENDIX A), with the latter having capacity to execute additional commands in the loop while the synchronized action in progress completes. However, using present embodiments, the need for programmatic loops is reduced to a minimum. One of ordinary skill in the art would recognize that is code vignette is solely for illustration and not the only manner to achieve a synchronized motion with an IISMC programmed with goal-specific programming material. Of course, many alternatives and combinations of programming materials can be formed for executing an action by one or more IISMC from APPENDIX A elements, and other information. One of ordinary skill in the art also would realize that it is possible to enqueue programming material while a synchronized trajectory motion is in progress, making possible a wide palette of synchronized trajectory motions and actions. Again, such supplemental positioning information could be preloaded into an IISMC or could be received by an IISMC from a sending IISMC while a move in the recipient is in progress, demonstrating coordinated communication between or among IISMC elements.

Synchronized actions can include multiple IISMC operating like a well-trained music band, with one IISMC playing alone or taking queues from one or more others. Of course, synchronized actions make be performed in the context of a relative position or an absolute position, or even in a combination of relative and absolute positions. The motion in a synchronized move generally may be defined along a predetermined combined path, which may be composed of predetermined individual target positions of one or more IISMC elements acting as a group. In embodiments of the present invention, it can be possible to execute combined path acceleration commands in which is defined the combined path acceleration of all contributing axes along the predetermined path. It also can be possible to execute combined path velocity commands in which is defined the combined path velocity of all contributing axes along the predetermined path, further contributing to precise, fluid, and synchronized motion. Accelerations or decelerations, velocities, or commutation modes, are among the parameters or information that may be independently set for an IISMC or a plurality of IISMC. IISMC may report commands to another contributing IISMC, as may be indicated for the preselected target position, combined path velocity, or combined path acceleration. In a trapezoidal motion profile, the IISMC rotor generally accelerates to a predetermined velocity, maintains that velocity for a portion of the motion, and decelerates from the predetermined velocity to a stop. A triangular motion profile similarly may be achieved without a constant velocity period. In a synchronized command, motion is achieved in synchronized fashion such that preselected programming materials and target parameters may cause the combined velocity of cooperating IISMC elements to reflect combined (vectorial) motion. Similarly, in synchronized acceleration, one or more IISMC may achieve maximum constant velocity nearly simultaneously, and a synchronized deceleration may cause one or more IISMC to return from constant maximum velocity to a stop nearly simultaneously. Programmed material or information, read, reported or supplemented programmatically in an IISMC (e.g., a PTS( ) command), or by another IISMC, may cause an IISMC to gather or to report last target positions or other information, across a cooperatively communicating IISMC network, and cause target a IISMC to undertake the action directed in the information. In addition, the combined axis move time can be stored or calculated, and reported to the appropriate IISMC. As a result, an IISMC is capable of being reached by address and receiving or transmitting information to cause a coordinated multiple axis move where the combined (vectorial) velocity or acceleration can be controlled, and synchronized motion to a selected location is achieved. Programming elements responsible for synchronized motion can operate within a respective IISMC in a respective network at a unique address by appending the address to a command, constant, or variable value. A delimiter may precede the address.

The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings, although not every figure may repeat each and every feature that has been shown in another figure in order to not obscure certain features or overwhelm the figure with repetitive indicia. It is understood that the invention is not limited to the specific methodology, devices, apparatuses, materials, applications, etc., described herein, as these may vary. It is also to be understood that the terminology used herein is used for the purpose of describing particular embodiments only, and is not intended to limit the scope of the invention.

APPENDIX A
COMMANDS

| COMMAND | MEANING |
|---|---|
| a . . . z | Get user variable |
| a = . . . z = | Set user variable |
| aa . . . zz | Get user variable |
| aa = . . . zz = | Set user variable |
| aaa . . . zzz | Get user variable |
| aaa = . . . zzz = | Set user variable |
| ab[index] | Get array variable 8 bit |
| ab[index] = . . . | Set array variable 8 bit |
| af[index] | Get float variable |
| af[index] = . . . | Set float variable |
| al[index] | Get array variable 32 bit |
| al[index] = . . . | Set array variable 32 bit |
| aw[index] | Get array variable 16 bit |
| aw[index] = . . . | Set array variable 16 bit |
| Ai(0) | Arm index rising edge of internal encoder |
| Ai(1) | Arm index rising edge of external encoder |
| Aij(0) | Arm index rising edge then falling edge internal encoder |
| Aij(1) | Arm index rising edge then falling edge external encoder |
| Aj(0) | Arm index falling edge of internal encoder |
| Aj(1) | Arm index falling edge of external encoder |
| Aji(0) | Arm index falling edge then rising edge internal encoder |
| Aji(1) | Arm index falling edge then rising edge external encoder |
| ABS( . . . ) | Get integer absolute value |
| AC | Get commanded acceleration |
| ACOS( . . . ) | Get arc-cosine in degrees |
| ADDR | Get motor's serial address |
| ADDR = . . . | Set serial address |
| ADT = . . . | Set acceleration and deceleration |
| ADTS = . . . | Set accel. and decel. for synchronized motion |
| AMPS | Get assigned max. drive PWM limit |
| AMPS = . . . | Set PWM drive signal limit |
| ASIN( . . . ) | Get arc-sine in degrees |
| AT | Get target acceleration |
| AT = . . . | Set acceleration |
| ATS = . . . | Set acceleration for synchronized motion |
| ATAN( ) | Get arc-tangent in degrees |
| ATOF( ) | Get ASCII to float conversion |
| B( ) | Get status bit |
| Ba | Get over current Status Bit |
| BAUD(0) | Get baud rate of channel 0. |
| BAUD(1) | Get baud rate of channel 1. |
| BAUD# | Set baud rate of channel 0. |
| BAUD(0) = . . . | Set baud rate of channel 0. |
| BAUD(1) = . . . | Set baud rate of channel 1. |
| Be | Get excessive position error Status Bit |
| Bh | Get excessive temperature Status Bit |
| Bi(0) | Get index captured Status Bit (rising, internal encoder) |
| Bi(1) | Get index captured Status Bit (rising, external encoder) |
| Bj(0) | Get index captured Status Bit (falling, internal encoder) |
| Bj(1) | Get index captured Status Bit (falling, external encoder) |
| Bk | Get EEPROM data integrity Status Bit |
| Bl | Get historical hardware left/negative limit Status Bit |
| Bls | Get historical software left/negative limit Status Bit |
| Bm | Get left/negative hardware limit Status Bit |
| Bms | Get left/negative software limit Status Bit |
| Bo | Get motor off Status Bit |
| Bp | Get right/positive hardware limit Status Bit |
| Bps | Get right/positive software limit Status Bit |
| Br | Get historical right/positive hardware limit Status Bit |
| Brs | Get historical right/positive software limit Status Bit |
| Bs | Get syntax error Status Bit |
| Bt | Get trajectory in progress Status Bit |
| Bv | Get velocity error fault |
| Bw | Get encoder wrap around Status Bit |
| Bx(0) | Get real time internal index input Status Bit |
| Bx(1) | Get real time external index input Status Bit |
| BREAK | Program execution flow control. |
| BRKENG | Brake engage |
| BRKRLS | Brake release |
| BRKSRV | Brake without servo |
| BRKTRJ | Brake without trajectory |
| C# | Program subroutine label |
| CADDR | Get CAN address |
| CADDR = . . . | Set CAN address |
| CAN | Get CAN error |
| CANCTL( . . . ) | Control network features |
| CASE # | Program flow instruction |
| CBAUD | Get CAN baudrate |
| CBAUD = . . . | Set CAN baudrate |
| CCHN( ) | Close a serial channel |
| CHN(0) | Get RS-232 communications error flags |
| CHN(1) | Get RS-485 communications error flags |
| CLK | Get 1 millisecond clock variable |
| CLK = . . . | Set 1 millisecond clock |
| COS( . . . ) | Get cosign of an angle in degrees |
| CP | Get cam pointer |
| CTA( . . . ) | Add cam table |
| CTE( . . . ) | Erase cam table(s) |
| CTR(0) | Get primary encoder/step and direction counter |
| CTR(1) | Get second encoder/step and direction counter |
| CTT | Get number of cam tables in EE |
| CTW( ) | Write cam table point |
| DEA | Get de/dt actual |
| DEFAULT | Switch-case structure element |
| DEL | Get the setting for de/dt fault limit |
| DEL = . . . | Set the de/dt fault limit |
| DFS( . . . ) | Get af[ ] variable in its raw 32-bit IEEE format. |
| DITR( . . . ) | Disable 1 or more individual interrupts |
| DT | Get deceleration setting |
| DT = . . . | Set deceleration |
| DTS = . . . | Set deceleration for synchronized motion |
| EA | Get actual position error |
| ECHO | Echo input data back out main channel |
| ECHO_OFF | Stop echo main channel |
| ECHO1 | Echo input data back out second channel |
| ECHO_OFF1 | Stop echo second channel |
| EIGN( . . . ) | Set one or more I/O pins to input |
| EILN | Activate negative hardware limit switch |
| EILP | Activate positive hardware limit switch |
| EIRE | Configure index capture pin to capture external encoder |
| EIRI | Configure index capture pin to capture internal encoder |
| EISM(6) | Confgure pin 6 to call G command |
| EITR( . . . ) | Enable one or more interrupts |
| EL | Get position error fault limit |
| EL = . . . | Set position error fault limit |
| ELSE | If structure element |
| ELSEIF | Else structure element |
| ENC0 | Select internal encoder for servo |
| ENC1 | Select external encoder for servo |
| END | End program |
| ENDIF | End if statement |
| ENDS | End switch structure |
| EOBK( . . . ) | Send brake signal to I/O output |
| EPTR | Get data EEPROM pointer |
| EPTR = . . . | Set data EEPROM pointer |
| ERRC | Get most recent command error code |
| ERRW | Get communication channel of most recent command error |
| F | Activate buffered PID settings |
| FABS( . . . ) | Get floating-point absolute error |
| FSA( . . . ) | Configure action upon fault |
| FSQRT( . . . ) | Get floating point square root |
| FW | Get firmware version as 32-bit field |
| G | Start motion (GO) |
| G( . . . ) | Start motion (GO) specific trajectory |
| GS | Start motion (GO) for synchronized move |
| GETCHR | Get character from main comm channel |
| GETCHR1 | Get character from second comm channel |
| GOSUB( . . . ) | Call a subroutine by literal number, or variable |
| GOSUB# | Call a subroutine |
| GOTO( . . . ) | Goto a program label by literal number, or variable |
| GOTO# | Goto a program label |
| HEX( . . . ) | Get a hex string into a variable |
| I(0) (capital i) | Get hardware index position variable (rising edge, internal encoder) |
| I(1) (capital i) | Get hardware index position variable (rising edge, external encoder) |
| IF . . . | Conditional test |
| IN( . . . ) | Get I/O input |
| INA( . . . ) | Get analog input |
| ITR( . . . ) | Configure user interrupt |
| ITRD | Global disable of user interrupts |
| ITRE | Global enable of user interrupts |
| J(0) | Get hardware index position variable (falling edge, internal encoder) |
| J(1) | Get hardware index position variable (falling edge, external encoder) |
| KA | Get the buffered PID setting for KA (acceleration feed-forward) |
| KA = . . . | Set the buffered PID setting for KA (acceleration feed-forward) |
| KC | Get the setting for KC |
| KC = . . . | Set KC |
| KCS | Get the setting for KCS |
| KCS = . . . | Set KCS |
| KD | Get the buffered PID setting for KD (Derivative term) |
| KD = . . . | Set the buffered PID setting for KD (Derivative term) |
| KG | Get the buffered PID setting for KG (gravity term) |
| KG = . . . | Set the buffered PID setting for KG (gravity term) |
| KI | Get the buffered PID setting for KI (integral term) |
| KI = | Set the buffered PID setting for KI (integral term) |
| KL | Get the buffered PID setting for KL (integral limit term) |
| KL = . . . | Set the buffered PID setting for KL (integral limit term) |
| KP | Get the buffered PID setting for KP (proportional term) |
| KP = | Set the buffered PID setting for KP (proportional term) |
| KS | Get the buffered PID setting for KS (derivative filter control) |
| KS = . . . | Set the buffered PID setting for KS (derivative filter control) |
| KV | Get the buffered PID setting for KV (velocity feed-forward) |
| KV = . . . | Set the buffered PID setting for KV (velocity feed-forward) |
| LEN | Main communications channel buffer fill level, data mode |
| LEN1 | Second communications channel buffer fill level, data mode |
| LFS( . . . ) | Get float value from 32-bit IEEE format |
| LOAD | Initiate program download to motor |
| LOCKP | Prevent program upload until new program is loaded |
| LOOP | While structure element |
| MC | Enable Cam Mode |
| MC( . . . ) | Enable Cam Mode, additional trajectory |
| MCE( . . . ) | Cam spline enable |
| MCW( . . . ) | Cam starting point |
| MDB | TOB commutation enable |
| MDC | Sine current commutation mode |
| MDE | Trapezoidal encoder commutation mode |
| MDS | Sine voltage commutation mode |
| MDT | Trapezoidal hall commutation mode |
| MF0 | Set CTR(1) to 0, and choose quadrature mode on external encoder |
| MFA( . . . ) | Follow Mode Ascend ramp |
| MFD( . . . ) | Follow Mode Decend ramp |
| MFDIV | Get Follow Mode divisor setting |
| MFDIV = . . . | Set Follow Mode divisor |
| MFMUL | Get Follow Mode multiplier setting |
| MFMUL = . . . | Set Follow Mode divisor |
| MFR | Choose Follow Mode with quadrature |
| MFR( . . . ) | Choose Follow Mode with quadrature, additional trajectory |
| MFSDC( . . . ) | Follow Mode stall-dwell-continue |
| MFSLEW( . . . ) | Follow Mode Slew |
| MINV( . . . ) | Invert commutation |
| MODE | Get Operating Mode |
| MODE( . . . ) | Get Operating Mode, specific trajectory |
| MP | Enable Position Mode |
| MP( . . . ) | Enable Position Mode, additional trajectory |
| MS0 | Set CTR(1) to 0, and choose step/direction mode on external encoder |
| MSR | Choose Follow Mode with step/direction |
| MSR( . . . ) | Choose Follow Mode with step/direction, additional trajectory |
| MT | Enable Torque Mode |
| MTB | Mode Torque Brake |
| MV | Enable Velocity Mode |
| MV( . . . ) | Enable Velocity Mode, additional trajectory |
| O = . . . | Set Origin |
| O( . . . ) = . . . | Set specific trajectory Origin |
| OC( . . . ) | Get output condition (24 volt IO) |
| OCHN( . . . ) | Open communications channel |
| OF( . . . ) | Get output faults (24 volt IO) |
| OFF | Stop servoing the motor |
| OR( . . . ) | Set 1 or more outputs to low |
| OS( . . . ) | Set 1 or more outputs to high |
| OSH = . . . | Shift Origin |
| OSH( . . . ) = . . . | Shift specific Origin |
| OUT( . . . ) = . . . | Set 1 or more outputs to a specific state |
| PA | Get actual motor position |
| PAUSE | Pause program execution |
| PC | Get commanded motor position |
| PC( . . . ) | Get commanded motor pos., specific trajectory |
| PI | Get the mathematical value pi |
| PID1 | 16,000 Hz PID rate |
| PID2 | 8,000 Hz PID rate (default) |
| PID4 | 4,000 Hz PID rate |
| PID8 | 2,000 Hz PID rate |
| PMA | Get actual position modulo |
| PML | Get position modulo limit setting |
| PML = . . . | Set position modulo limit |
| PMT | Get position modulo target (position move) |
| PMT = . . . | Set position modulo target (position move) |
| PRA | Get actual position relative to move start |
| PRC | Get commanded position relative to move start |
| PRINT( . . . ) | Print data to main communications channel |
| PRINT1( . . . ) | Print data to second communications channel |
| PRT | Get position relative target setting |
| PRT = . . . | Set position relative target |
| PRTS( . . . ) | Set position target synchronized relative |
| RTSS( . . . ) | Set supplemental position target synchronized relative |
| PT | Get position target setting |
| PT = . . . | Set position target |
| PTS = ( . . . ) | Set position target synchronized absolute |
| PTSS = ( . . . ) | Set supplemental position target synchronized absolute |
| PTSD | Get synchronized move linear distance |
| PTST | Get synchronized move linear time |
| Ra . . . Rz | Report variables |
| Raa . . . Rzz | Report variables |
| Raaa . . . Rzzz | Report variables |
| Rab[index] | Report byte array variables (8-bit) |
| Raf[index] | Report float array variables |
| Ral[index] | Report long array variables (32-bit) |
| Raw[index] | Report word array variables (16-bit) |
| RABS( . . . ) | Report integer absolute value |
| RAC | Report commanded acceleration |
| RACOS( . . . ) | Report arc-cosine in degrees |
| RADDR | Report motor's serial address |
| RAMPS | Report assigned max. drive PWM limit |
| RANDOM | Get the next value from random generator e.g. a = RANDOM |
| RANDOM = . . . | Set the random generator seed |
| RASIN( . . . ) | Report arc-sine in degrees |
| RAT | Report target acceleration |
| RATAN( . . . ) | Report arc-tangent in degrees |
| RATOF( . . . ) | Report ASCII to float conversion |
| RB( . . . ) | Report Status Bit |
| RBa | Report over current Status Bit |
| RBAUD(0) | Report baud rate of channel 0. |
| RBAUD(1) | Report baud rate of channel 1. |
| RBe | Report excessive position error Status Bit |
| RBh | Report excessive temperature Status Bit |
| RBi(0) | Report index captured Status Bit (rising, internal encoder) |
| RBi(1) | Report index captured Status Bit (rising, external encoder) |
| RBj(0) | Report index captured Status Bit (falling, internal encoder) |
| RBj(1) | Report index captured Status Bit (falling, external encoder) |
| RBk | Report EEPROM data integrity Status Bit |
| RBl | Report historical hardware left/negative limit Status Bit |
| RBls | Report historical software left/negative limit Status Bit |
| RBm | Report left/negative hardware limit Status Bit |
| RBms | Report left/negative software limit Status Bit |
| RBo | Report motor off Status Bit |
| RBp | Report right/positive hardware limit Status Bit |
| RBps | Report right/positive software limit Status Bit |
| RBr | Report historical right/positive hardware limit Status Bit |
| RBrs | Report historical right/positive software limit Status Bit |
| RBs | Report syntax error Status Bit |
| RBt | Report trajectory in progress Status Bit |
| RBv | Report velocity error fault |
| RBw | Report encoder wrap around Status Bit |
| RBx( . . . ) | Report real time index input Status Bit |
| RCADDR | Report CAN address |
| RCAN | Report CAN error |
| RCBAUD | Report CAN baudrate |
| RCHN(0) | Report RS-232 communications error flags |
| RCHN(1) | Report RS-485 communications error flags |
| RCKS | Report program checksum |
| RCLK | Report 1 millisecond clock variable |
| RCOS( . . . ) | Report cosine of an angle in degrees |
| RCP | Report cam pointer |
| RCTR(0) | Report primary encoder/step and direction counter |
| RCTR(1) | Report second encoder/step and direction counter |
| RCTT | Report number of cam tables in EE |
| RDEA | Report DE/Dt actual |
| RDEL | Report the setting for DE/Dt fault limit |
| RDFS | Report af[ ] variable in its raw 32-bit IEEE format. |
| RDT | Report deceleration setting |
| REA | Report actual position error |
| REL | Report position error fault limit |
| REPTR | Report data EEPROM pointer |
| RERRC | Report most recent command error code |
| RERRW | Report communication channel of most recent command error |
| RES | Get encoder resolution. e.g. a = RES |
| RESUME | Continue program execution after a pause |
| RETURN | Return from subroutine |
| RETURNI | Return from interrupt routine |
| RFABS( . . . ) | Report floating-point absolute error |
| RFSQRT( . . . ) | Report floating point square root |
| RFW | Report firmware version as 32-bit field |
| RGETCHR | Report character from main communication channel |
| RGETCHR1 | Report character from second communication channel |
| RHEX( . . . ) | Report a hex string into a variable |
| RI(0) | Report hardware index position variable (rising edge, internal encoder) |
| RI(1) | Report hardware index position variable (rising edge, external encoder) |
| RIN( . . . ) | Report I/O input |
| RINA( . . . ) | Report analog input |
| RJ(0) | Report hardware index position variable (falling edge, internal encoder) |
| RJ(1) | Report hardware index position variable (falling edge, external encoder) |
| RKA | Report the buffered PID setting for KA(accelera-tion feed-forward) |
| RKC | Report the setting for KC |
| RKCS | Report the setting for KCS |
| RKD | Report the buffered PID setting for KD(deriva-tive term) |
| RKG | Report the buffered PID setting for KG(gravity term) |
| RKI | Report the buffered PID setting for KI(integral term) |
| RKL | Report the buffered PID setting for KL(integral limit term) |
| RKP | Report the buffered PID setting for KP(proportional term) |
| RKS | Report the buffered PID setting for KS(derivative filter control) |
| RKV | Report the buffered PID setting for KV(velocity feed-forward) |
| RLEN | Main com channel buffer fill level, data mode |
| RLEN1 | Second com channel buffer fill level, data mode |
| RLFS( . . . ) | Report float value from 32-bit IEEE format |
| RMFDIV | Report Follow Mode divisor setting |
| RMFMUL | Report Follow Mode multiplier setting |
| RMODE | Report Operating Mode |
| RMODE( . . . ) | Report Operating Mode, specific trajectory |
| ROC( . . . ) | Report output condition (24 volt IO) |
| ROF( . . . ) | Report output faults (24 volt IO) |
| RPA | Report actual motor position |
| RPC | Report commanded motor position |
| RPC( . . . ) | Report commanded motor position, specific trajectory |
| RPI | Report the mathematical value pi |
| RPMA | Report actual position modulo |
| RPML | Report position modulo limit setting |
| RPMT | Report position modulo target (position move) |
| RPRA | Report actual position relative to move start |
| RPRC | Report commanded position relative to move start |
| RPRT | Report position relative target setting |
| RPT | Report position target setting |
| RPTSD | Report synchronized move linear distance |
| RPTST | Report synchronized move time (ms) |
| RRANDOM | Report the next value from random generator |
| RRES | Report encoder resolution. |
| RSAMP | Report sample rate (Hz) |
| RSIN( . . . ) | Report sine of angle in degrees |
| RSLM | Report soft limit mode |
| RSLN | Report soft limit left/negative setting |
| RSLP | Report soft limit right/positive setting |
| RSP | Report sample rate and firmware string |
| RSP1 | Report firmware compile date |
| RSP2 | Report bootloader revision |
| RSQRT( . . . ) | Report integer square root |
| RT | Report current requested torque |
| RTAN( . . . ) | Report tangent of angle in degrees |
| RTEMP | Report temperature in degrees |
| RTH | Report temperature limit setting |
| RTHD | Report current limit timer setting |
| RTMR( . . . ) | Report user timer |
| RTRQ | Report torque real-time |
| RTS | Report torque slope setting |
| RUIA | Report current |
| RUJA | Report voltage |
| RUN | Execute stored program |
| RUN? | End if the RUNcommand has not been issued since powerup |
| RVA | Report actual velocity (filtered) |
| RVC | Report commanded velocity |
| RVL | Report velocity limit setting |
| RVT | Report target velocity |
| RW( . . . ) | Report a specific status word |
| S | Stop move in progress abruptly |
| S( . . . ) | Stop move in progress abruptly, specific trajectory |
| SADDR# | Set motor to new address |
| SAMP | Get sample rate (Hz) |
| SILENT | Suppress PRINTmessages main channel |
| SILENT1 | Suppress PRINTmessages second channel |
| SIN( . . . ) | Get sine of angle in degrees |
| SLD | Disable software limits |
| SLE | Enable software limits |
| SLEEP | Initiate Sleep Mode main channel |
| SLEEP1 | Initiate Sleep Mode second channel |
| SLM | Get Soft Limit Mode. e.g. a = SLM |
| SLM( . . . ) | Set Soft Limit Mode |
| SLN | Get left/negative software limit |
| SLN = . . . | Set left/negative software limit |
| SLP | Get right/positive software limit |
| SLP = . . . | Set right/positive software limit |
| SQRT( . . . ) | Get integer square root |
| SRC( . . . ) | Set follow and/or cam encoder source |
| STACK | Reset nesting stack tracking |
| STDOUT = . . . | Set where report commands are printed to |
| SWITCH . . . | Program execution control |
| T | Get the target torque setting |
| T = | Set target torque |
| TALK | Enable PRINTmessages on main channel |
| TALK1 | Enable PRINTmessages on main channel |
| TAN( . . . ) | Get tangent of an angle in degrees |
| TEMP | Get temperature |
| TH | Get temperature limit setting |
| TH = . . . | Set temperature limit |
| THD | Get current limit timer setting |
| THD = . . . | Sets current limit timer delay |
| TMR( . . . ) | Get a specific user timer value. e.g. a = TMR(0) |
| TMR( . . . ) (as cmd) | Set a user timer. e.g. TMR(0, 1000) |
| TRQ | Get torque real-time |
| TS | Get torque slope setting |
| TS = . . . | Set torque slope |
| TSWAIT | Pause program during a synchronized move |
| TWAIT | Pause program during a move |
| TWAIT( . . . ) | Pause program during a move, specific trajectory |
| UIA | Get motor current |
| UJA | Get bus voltage |
| UO( . . . ) = . . . | Set one or more user Status Bits to specific values |
| UP | Upload user EEPROM program contents |
| UPLOAD | Upload user EEPROM readable program |
| UR( . . . ) | Set one or more user status bits to a 0. |
| US( . . . ) | Set one or more user status bits to a 1. |
| VA | Get actual velocity (filtered) |
| VAC( . . . ) | Set velocity filter |
| VC | Get commanded velocity |
| VL | Get velocity limit setting |
| VL = . . . | Set velocity limit |
| VLD( . . . ) | Sequentially load variables from data EEPROM |
| VST( . . . ) | Sequentially store variables to data EEPROM |
| VT | Get velocity target setting |
| VT = . . . | Set velocity target |
| VTS = . . . | Set position target for synchronized motion |
| W( . . . ) | Report a specific status word |
| WAIT = . . . | Suspends program for number of milliseconds |
| WAKE | Terminate Sleep Mode main channel |
| WAKE1 | Terminate Sleep Mode second channel |
| WHILE . . . | Conditional program flow command |
| X | Slow motor motion to stop |
| X( . . . ) | Slow motor motion to stop, specific trajectory |
| Z | Total system reset |
| Z( . . . ) | Reset a particular Status Bit |
| Za | Reset current limit violation latch bit |
| Ze | Reset position error fault |
| Zh | Reset temperature fault |
| Zl | Reset historical left/neg. hardware limit latch bit |
| Zls | Reset historical left/neg. software limit latch bit |
| Zr | Reset historical right/pos. hardware limit latch bit |
| Zrs | Reset historical right/pos. software limit latch bit |
| Zs | Reset syntax error bit |
| ZS | Reset system latches to power-up state |
| Zv | Reset velocity error fult |
| Zw | Reset encoder wrap around event latch bit |

What is claimed is:

1. An motor controller, comprising:
an integrated motor controller element having
a motor having a rotor,
a serial data communications port coupled to the microprocessor and to at least one other integrated servomotor controller element cooperatively communicating a selected rotor position command,
wherein the cooperative communication facilitates a synchronized action with the at least one other integrated motor controller element, and
wherein the integrated motor controller is an intelligent integrated motor controller locatable by information having an appended preselected controller address.

2. The motor controller of claim 1, wherein the synchronized action further comprises the cooperative multi-axis coordinated action with at least two intelligent integrated motor controllers effecting a controlled combined path velocity move.

3. The motor controller of claim 1, wherein the synchronized action further comprises the cooperative multi-axis coordinated action with at least two intelligent motor controllers effecting a controlled combined path acceleration move.

4. The motor controller of claim 1, wherein the cooperative multi-axis coordinated action between at least two intelligent integrated motor controller elements further comprises a two-axis move cooperatively communicated from a first of the at least two intelligent integrated motor controller elements to a second of the at least two intelligent integrated motor controller elements.

5. The motor controller of claim 1, wherein the cooperative multi-axis coordinated action further comprises a three-axis move cooperatively communicated from a first of the at least two intelligent integrated motor controller elements to a second of the at least two intelligent integrated motor controller elements to a third of at least two intelligent integrated motor controller elements.

6. The motor controller of claim 1, further comprising:
a rotor position encoder that produces a signal indicating a rotor measured position,
a microprocessor electrically coupled to the motor and receiving the signal indicating a rotor measured position,
wherein cooperative multi-axis coordinated action between at least two intelligent integrated servomotor controller elements further comprises a coordinated three-axis move cooperatively communicated among a first of the at least two intelligent integrated servomotor controller elements, a second of the at least two intelligent integrated servomotor controller elements and a third intelligent integrated servomotor controller element, and wherein the microprocessor executes programming material that reduces to zero error signals between the selected rotor position command and the rotor measured position.

7. The motor controller of claim 6, wherein the cooperative multi-axis coordinated action between the first, the second, and the third integrated servomotor controller elements further comprises one of a three-axis controlled combined path velocity move or a three-axis controlled combined path acceleration move.

8. The motor controller of claim 6, wherein the cooperative multi-axis coordinated action between the first, the second, and the third intelligent integrated servomotor controller elements further comprises a command communicated by one of the first, the second, and the third integrated servomotor controller elements another of the integrated servomotor controller elements.

9. A method of operating an integrated motor controller (IMC) element in an IMC group, comprising:
cooperatively communicating to selected ones of the IMC group;
setting a combined path target acceleration for the IMC group;
setting a combined path target velocity for the IMC group;
setting individual target positions for selected ones of the IMC group;
initiating a synchronized motion in the IMC group,
wherein each of the respective selected ones reaches its respective individual target position at the same time;
and
wherein the IMC is an intelligent integrated motor controller (IIMC) locatable by a preselected controller address communicated to the IMC group.

10. The method of claim 9, wherein the cooperatively communicating further comprises cooperatively communicating to selected ones of the IMC group an identified address corresponding to the IIMC controller.

11. The method of claim 9, further comprising forming an IIMC network from at least two IIMC groups.

12. The method of claim 9, further comprising:
after initiating, receiving addressed information corresponding to a second synchronized motion;
waiting for the synchronized motion to complete; and
initiating the second synchronized motion.

13. The method of claim 9, further comprising:
after initiating, enqueuing addressed information corresponding to a second synchronized motion;
waiting for the synchronized motion to complete; and
initiating the second synchronized motion.

14. The method of claim 12, further comprising:
executing an programming element of programming material; and
initiating a subsequent synchronized motion.

15. A servocontroller, comprising:
a locate-by-reference addressable integrated motor;
an encoder coupled to the integrated motor; and
a feedback control loop coupled between the locate-by-reference addressable integrated motor and the encoder,
wherein the feedback control loop responds to the motor relative to the encoder, and
wherein the locate-by-reference addressable integrated motor has a address unique relative to another locate-by-reference addressable integrated motor, and wherein the reference to a motor address is appended to a motor command.

16. The servocontroller of claim 15, wherein the locate-by-reference addressable integrated motor further comprises an alternating current (AC) motor.

17. The servocontroller of claim 15, wherein the locate-by-reference addressable integrated motor further comprises a direct current (DC) motor.

18. The servocontroller of claim 15, wherein the locate-by-reference addressable integrated motor further comprises a stepper motor.

19. The servocontroller of claim 15, wherein the feedback control loop further comprises an adaptive error-minimizing feedback control loop.

20. The servocontroller of claim 15, wherein locate-by-reference addressable integrated motor is configured to perform a synchronized move directed by a command from a locate-by-reference addressable integrated motor.
